(19) United States
(12) Patent Application Publication
(10) Pub. No.: US 2018/0203389 A1
(43) Pub. Date: Jul. 19, 2018

(54) IMAGE HEATING APPARATUS

(71) Applicant: CANON KABUSHIKI KAISHA, Tokyo (JP)

(72) Inventor: Noriaki Adachi, Inzai-shi (JP)

(21) Appl. No.: 15/870,135

(22) Filed: Jan. 12, 2018

Related U.S. Application Data
(63) Continuation of application No. PCT/JP2016/071463, filed on Jul. 14, 2016.

(30) Foreign Application Priority Data
Jul. 14, 2015 (JP) 2015-140406

(51) Int. Cl. G03G 15/20; G03G 15/00

(52) U.S. Cl. CPC G03G 15/2078; G03G 15/80

(57) ABSTRACT

An image heating apparatus includes first and second rotatable members forming a nip for heating a toner image on a sheet, a first heater for heating the first rotatable member, having a heat generation power higher in a central portion than in opposite end portions with respect to a longitudinal direction of the first rotatable member, and a second heater for heating the first rotatable member, having a heat generation power higher in opposite end portions than in a central portion with respect to the longitudinal direction. A controller controls power supply to the first and second heaters in response to an output of a first sensor. In a stand-by state, the controller controls power supply to the first heater in response to the output of the first sensor and power supply to the second heater in response to an output of a second sensor.

### CLAIM OF PRIORITY

This application is a continuation of International Patent Application No. PCT/JP2016/071463, filed Jul. 14, 2016.

### FIELD OF THE INVENTION

The present invention relates to an image heating apparatus for heating a toner image on a sheet.

### BACKGROUND ART

In a known image forming apparatus, such as a copying machine, the toner image is formed on the recording material (sheet), and, thereafter, the toner image on the sheet is heated by a fixing device (image heating apparatus). In such a fixing device, a halogen heater is used.

With the halogen heater, an inrush of current upon activation is so large that a voltage variation occurs due to the impedance of the wiring. Japanese Laid-open Patent Application Hei 11-102128 proposes an apparatus in which the inrush of current is suppressed by a phase control to reduce flickering. Japanese Laid-open Patent Application 2003-295685 proposes that the inrush current is suppressed to reduce the flickering, by making light timings of two heaters different from each other.

However, such methods alone are not sufficient to suppress the flickering with stabilized fixing properties.

### SUMMARY OF THE INVENTION

### Problem to be Solved

Accordingly, it is an object of the present invention to suppress flickering while keeping satisfactory image heating.

### Means for Solving the Problem

According to one aspect, present invention provides an image heating apparatus comprising a first rotatable member and a second rotatable member for constituting a nip for heating a toner image on a sheet, a first heater for heating the first rotatable member, the first heater having a heat generation power that is higher in a central portion than in opposite end portions with respect to a longitudinal direction of the first rotatable member, a second heater for heating the first rotatable member, the second heater having a heat generation power that is higher in opposite end portions than in a central portion with respect to the longitudinal direction of the first rotatable member, a first sensor for detecting a temperature of a central portion of the first rotatable member with respect to the longitudinal direction, a second sensor for detecting a temperature of an end portion of the first rotatable member with respect to the longitudinal direction, and a controller for controlling electrical power supply to the first heater and the second heater, wherein, in an image heating process operation, the controller controls the electrical power supply to the first heater and the second heater in response to an output of the first sensor, and wherein, in a stand-by state, the controller controls the electrical power supply to the first heater a response to the output of the first sensor and controls the electrical power supply to the second heater in response to an output of the second sensor. According to another aspect, the present invention provides an image heating apparatus comprising a first rotatable member and a second rotatable member for constituting a nip for heating a toner image on a sheet, a first heater for heating the first rotatable member, the first heater having a heat generation power that is higher in a central portion than in opposite end portions with respect to a longitudinal direction of the first rotatable member, a second heater for heating the first rotatable member, the second heater having a heat generation power that is higher in opposite end portions than in a central portion with respect to the longitudinal direction of the first rotatable member, a first sensor for detecting a temperature of a central portion of the first rotatable member with respect to the longitudinal direction, a second sensor for detecting a temperature of an end portion of the first rotatable member with respect to the longitudinal direction, and a controller for controlling electrical power supply to the first heater and the second heater, wherein, in an image heating process operation, the controller controls the electrical power supply to the first heater and the second heater in response to an output of the first sensor, and wherein, in a warming-up period, the controller controls the electrical power supply to the first heater in response to an output of the first sensor and controls the electrical power supply to the second heater in response to an output of the second sensor.

### BRIEF DESCRIPTION OF THE DRAWINGS

FIG. 1 is a sectional view of an image forming apparatus provided with a fixing device.

FIG. 2 illustrates a structure of a heating portion of the fixing device.

FIG. 3 is a control block diagram.

FIG. 4 is a timing chart showing a relationship between a thermister temperature and ON/OFF of a halogen heater.

Part (a) of FIG. 5 shows an arrangement in a case that both heaters are controlled using one thermister, and part (b) of FIG. 5 shows temperature changes in a case that the heaters are controlled using respective thermisters.

FIG. 6 is a flow chart of heater control.

### EMBODIMENTS FOR CARRYING OUT THE INVENTION

In the following, embodiments for carrying out the present invention will be described with reference to the drawings.

### First Embodiment

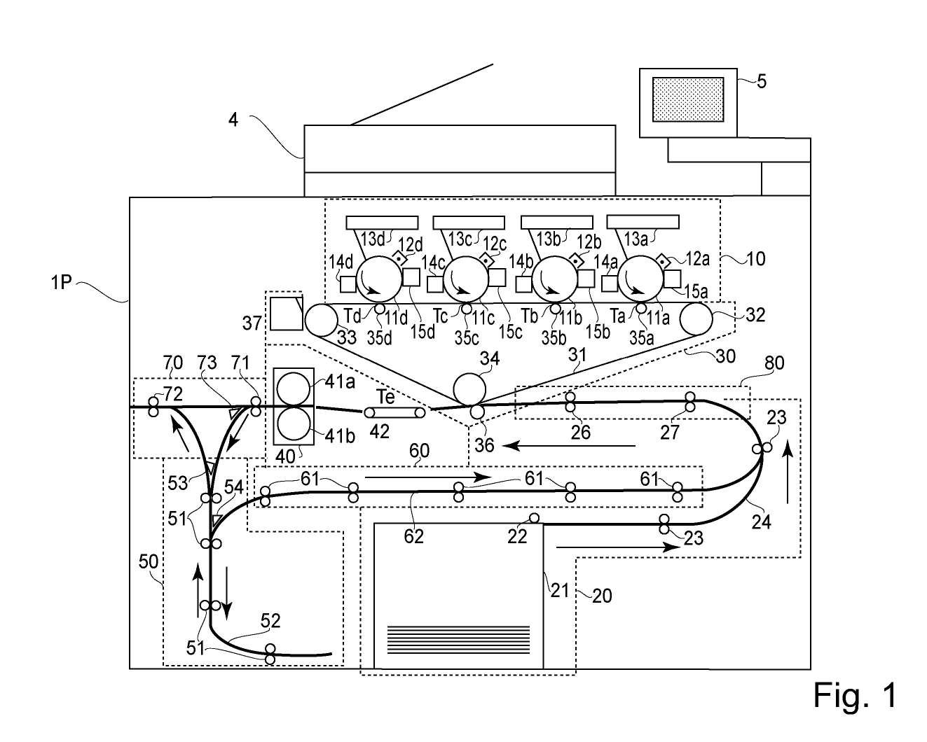

FIG. 1 is a structural view of a color image forming apparatus as an image forming apparatus in which a fixing device according to this embodiment is mounted. In the color image forming apparatus shown in the figure, an image outputting portion 1P exists, and, at an upper portion of the image outputting portion 1P, a reader portion 4 and an operating portion 5 are mounted. An operator operates the apparatus at the operating portion 5, whereby the operator reads an image of an original at the reading portion 4 and can perform copying and can output the image on the basis of image data stored in an unshown hard disk drive.

This image outputting portion 1P is constituted by a control device roughly including an image forming portion 10, a sheet feeding unit 20, an intermediary transfer unit 30, a fixing unit 40 as a fixing device, a reversing double-side (printing) unit 50, a double-side (printing) feeding unit 60, a sheet discharging unit 70, and a feeding unit 80. In the image forming portion 10, four stations a, b, c, and d are juxtaposed, and their structures are the same. Further, the fixing unit 40 as an image heating device, the double-side feeding unit 60 and the feeding unit 80 are constituted by a fixing feeding device, and can be easily pulled out from the image forming apparatus.

Here, individual units will be described specifically. In the image forming portion 10, photosensitive drums (hereinafter, drums) 11a, 11b, 11c, and 11d as image bearing members rotationally driven in indicated arrow directions are shaft-supported at centers thereof. Further, while opposing outer peripheral surfaces of the drums 11a, 11b, 11c, and 11d, primary chargers 12 (12a, 12b, 12c, 12d), optical systems 13 (13a, 13b, 13c,13d) and developing device 14 (14a, 14b, 14c, 14d) are provided along a rotational direction of the drums 11a-11d.

Further, by the primary chargers 12a-12d, electrical charges with uniform charge amounts are imparted to the drums 11a-11d. Then, by the optical systems 13a-13d, the drums 11a-11d are exposed to light beams such as laser beams, for example, modulated depending on recording image signals, so that electrostatic latent images are formed. Then, the respective electrostatic latent images are visualized as toner images by the developing devices 14a-14d accommodating developers (toners) of four colors of yellow, cyan, magenta, and black, respectively.

Incidentally, on downstream sides of image primary transfer regions Ta, Tb, Tc, and Td, where the visualized toner images are transferred onto an intermediary transfer belt 31, toners remaining on the drums 11a-11d, without being transferred on a sheet material (recording material) P, are removed. That is, the toners remaining on the drums 11a-11d are scraped off by cleaning devices 15 (15a, 15b, 15c, 15d), so that surfaces of the drums 11a-11d are cleaned. Through the above-described process, image formation by the respective toners is successively carried out.

On the other hand, the sheet feeding unit 20 includes a cassette 21 for accommodating the sheet material P and a pick-up roller pair 22 for feeding the sheet material P from the cassette 21 one by one. Further, the sheet feeding unit 20 includes feeding roller pairs 23 for feeding the sheet material, sent from the pick-up roller pair 22, to a pre-registration roller pair 27 and includes a feeding guide 24.

Further, a registration unit 80 is constituted by the pre-registration roller pair 27 and a registration roller pair 26 for not only correcting oblique movement of the sheet material P, but also feeding the sheet material P to a secondary transfer portion Te in synchronism with image forming timing.

Further, the intermediary transfer unit 30 includes an intermediary transfer belt 31 as an intermediary transfer member. The intermediary transfer belt 31 is wound around a driving roller (downstream roller) 32 for transmitting a driving force thereto and a tension roller (upstream roller) 33 for imparting a proper tension to the intermediary transfer belt 31 by an urging force of an unshown spring (urging member). Further, the intermediary transfer belt 31 ids wound around an inner secondary transfer roller 34 opposing the secondary transfer region Te, while sandwiching the intermediary transfer belt 31 therebetween.

In the primary transfer regions Ta-Td where the respective drums 11a-11d oppose the intermediary transfer belt 31, primary transfer devices 35a-35d as primary transfer means are provided on the back side of the intermediary transfer belt 31. Further, in the secondary transfer region Te, where the inner secondary transfer roller 34 opposes an outer secondary transfer roller 36, a secondary transfer device as a secondary transfer means is provided (not shown). Further, downstream of the secondary transfer region Te on the intermediary transfer belt 31, a cleaning device 37 for cleaning an image forming surface of the intermediary transfer belt 31, is provided.

The fixing unit 40 as the image heating apparatus includes, as two rotatable members, a fixing roller 41a including a halogen heater as a heating source therein and a pressing roller 41b pressed against the fixing roller 41a, (In some cases, this pressing roller 41b includes the heating source.) The fixing roller 41a and the pressing roller 41b form a nip (fixing nip) through which the recording material (sheet) on which the toner images are formed by the image forming portion is nipped and fed. Further, the fixing unit 40 includes a pre-fixing guide 42 for guiding the sheet material P to the nip of the fixing roller 41a and the pressing roller 41b.

The discharging portion 70 is constituted by an inner discharging roller pair 71 for feeding the sheet material P after being heat-fixed by the fixing unit 40, an outer discharging roller pair 72 for guiding the sheet material P to an outside the apparatus, and a flapper 73 for guiding the sheet material P in a direction of the reverse double-side unit 50 or a direction of the outer discharging roller pair 72.

The reverse double-side unit 50 includes a reverse double-side (printing) roller pair 51 capable of being normally and reversely rotated, a reverse double-side (printing) guide 52, and a sheet discharging flapper 53 for guiding the sheet material P, reversed by the reverse double-side guide 52 during reverse sheet discharge, in a direction of the outer discharging roller pair 72. Further, reverse double-side unit 50 includes a double-side (printing) flapper 54 for guiding the sheet material P in a direction of the double-side feeding unit 60 during double-side printing. Further, the double-side feeding unit 60 consists of a double-side (printing) feeding roller pair 61 for feeding the sheet material P and a double-side (printing) feeding guide 62 for guiding the sheet material P.

Next, an operation of the color image forming apparatus will be described. When an image forming operation start signal is sent, first, the sheet materials P are fed from the cassette 21, one by one, by the pick-up roller pair 22. Then, the sheet material P is guided between the feeding guides 24 by the feeding roller pair 23 and is fed to the pre-registration roller pair 27 driven in a contact state, and is fed to the registration roller pair 26. At this time, the registration roller pair 26 is at rest. In this state, the sheet material P is abutted against the registration roller pair 26, so that a loop of the sheet material is formed and, thus, the oblique movement is rectified.

Thereafter, in synchronism with timing of a start of formation of the image of the image forming portion 10, the registration roller pair 26 starts rotation. As regards rotation timing of the registration roller pair 26, the timing is set so that the sheet material P just coincides in the secondary transfer region Te with the toner images primary-transferred onto the intermediary transfer belt 31 by the image forming portion 10.

On the other hand, in the image forming portion 10, when the image forming operation start signal is sent, the toner image formed on an uppermost-stream drum 11d is primary-transferred onto the intermediary transfer belt 31 in the primary transfer region Td by the primary transfer device 35d to which a high-voltage is applied. Then, the toner image primary-transferred onto the intermediary transfer belt 31 is fed to a subsequent primary transfer region Tc. In the primary transfer region Tc, image formation is carried out with a delay of a time in which the toner image is fed between parts of the image forming portion 10, so that a subsequent toner image is transferred onto the previous toner image in registration with the previous toner image.

Also, in the following, similar steps are repeated, so that four color toner images are primary-transferred onto the intermediary transfer belt 31.

Thereafter, when the sheet material P enters the secondary transfer region Te and contacts the intermediary transfer belt 31, a high-voltage is applied to a secondary transfer device in synchronism with passage timing of the sheet material P. Then, the four color toner images formed on the intermediary transfer belt 31 by the above-described process is transferred onto the surface of the sheet material P. Then, the sheet material P on which the toner images are transferred is accurately guided to the nip, of the fixing roller 41a and the pressing roller 41b of the fixing unit 40, by the pre-fixing guide 42.

Then, the toner images are fixed on the sheet material P by heat and pressure of the roller pairs 41a and 41b of the fixing unit 40. The sheet material P, on which the toner images are transferred, is sent out by the inner discharging roller pair 71.

During reverse sheet discharge or when back-side printing is carried out after front-side printing during the double-side printing, the sheet material P is fed in a direction of the double-side reverse unit 50 by the flapper 73. During one-side printing or after the back-side printing during the double-side printing, the flapper 73 operates so as to guide the sheet material P in a direction of the outer discharging roller pair 72, so that the sheet material P is discharged from the image outputting portion 1P by the outer discharging roller pair 72.

Further, the sheet material P drawn to the double-side reverse unit 50 is stopped by being drawn to a rear of the double-side reverse guide 52 by the double-side reverse roller pair 51. Thereafter, the double-side reverse roller pair 51 is reversely rotated, and the sheet material P is guided and fed by a double-side flapper 54 in the direction of the outer discharging roller pair 72, in the case of the reverse sheet discharge and in the direction of the double-side feeding unit 60, in the case of the double-side printing. Further, in the case of the reverse sheet discharge, the sheet material P passes through the double-side flapper 54 and then is guided in the direction of the outer discharging roller pair 72 by the sheet discharging flapper 53, and is discharged from the image outputting portion 1P by the outer sheet discharging roller pair 72.

During the double-side printing, the sheet material P guided to the double-side feeding unit 60 by the double-side flapper 54 is fed by the double-side feeding roller pair 61 and is guided to the double-side guide 62, and then, merges with a feeding guide 24 of the sheet feeding unit 20. Thereafter, the sheet material P is subjected to a process similar to that in the front-side printing, and is discharged to an outside of the image outputting portion 1P by the outer discharging roller pair 72.

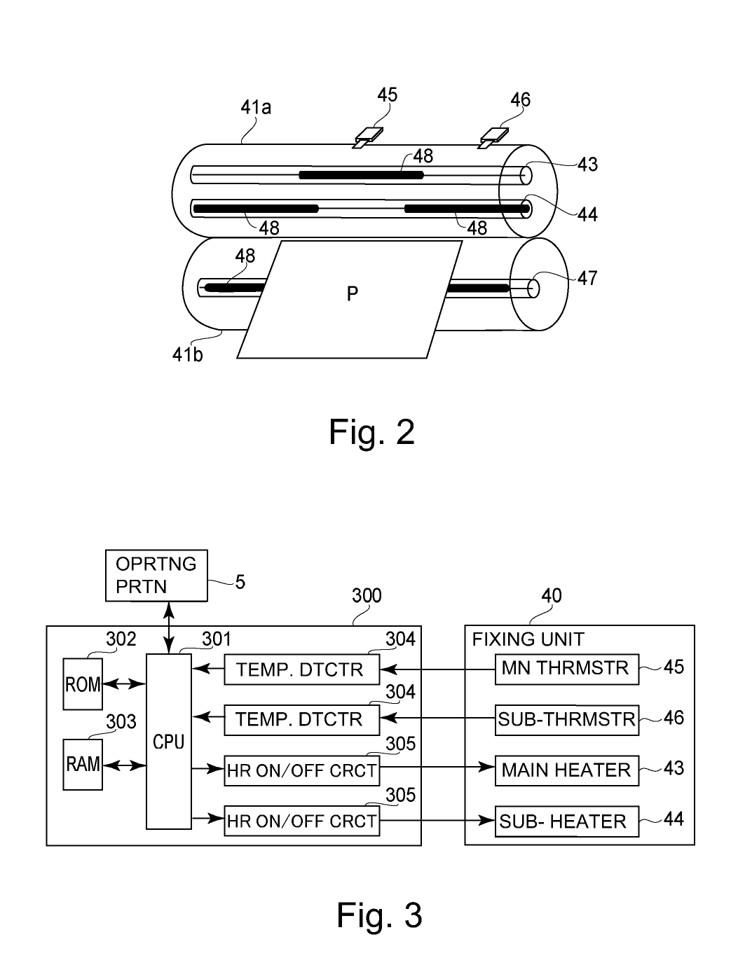

FIG. 2 is a structural view of a heating portion of the fixing unit 40 as the image heating apparatus of this embodiment. As shown in FIG. 2, as the heating portion of the fixing unit 40, heaters 43, 44 and 47, and thermistors 45 and 46, are provided.

Specifically, a halogen heater 43 as a first heater and a halogen heater 44 as a second heater, which are used for heating the fixing roller 41a, are provided in the fixing roller 41a, and a halogen heater 47 for heating the pressing roller 41b is provided in the pressing roller 41b. The halogen heaters in the fixing roller 41a are constituted by a main heater 43 for heating a central portion with respect to a direction (longitudinal direction) crossing a recording material feeding direction and by a sub-heater 44 for heating an end portion with respect to the longitudinal direction.

In the main heater 43, a filament 48 is provided at a central portion with respect to the longitudinal direction, so that a constitution, in which heat-generating power of the main heater 43 at the central portion with respect to the longitudinal direction is higher than that of the main heater 43 at both end portions, is employed. Further, in the sub-heater 44, filaments 48 are provided at both end portions with respect to the longitudinal direction of the fixing roller 41a, so that a constitution, in which heat-generating power of the sub-heater 44 at both end portions with respect to the longitudinal direction is higher than that of the sub-heater 44 at the central portion, is employed.

Further, in FIG. 2, a main thermistor 45, as a first thermistor, and a sub-thermistor 46, as a second thermistor, which are elements for temperature detection (for temperature monitoring) are attached in the form of contacting the fixing roller 41a. Specifically, the thermistors are constituted by the main thermistor 45 for detecting a temperature of the fixing roller 41a at a central portion with respect to the longitudinal direction and the sub-thermistor 46 for detecting the temperature of the fixing roller 41a at an end portion with respect to the longitudinal direction. Further, a controller (described later) converts a signal from the thermistor into temperature information and effects turning-on control (time-division control such that heating (turning-on) and non-heating (turning-off) are repeated periodically) of the respective heaters so that the temperature is a predetermined value.

FIG. 3 is a control block diagram for effecting control of the heating portion in this embodiment. A controller 300 includes a CPU 301 for effecting all pieces of control, an ROM 302 in which program data and temperature tables of the thermistors, and an RAM 303 for performing a computation process, data development, and the like, of the CPU 301. The controller 300 further includes a temperature detecting circuit 304 for converting signals of the main thermistor 45 and the sub-thermistor 46 into a voltage signal and for sending the voltage signal to the CPU 301 and includes a heater ON/OFF circuit 305 for receiving an instruction from the CPU 301 and for effecting turning-on control of the halogen heaters 43 and 44.

The heater ON/OFF circuit 305 as a power source circuit (energizing circuit, energizing means), for supplying electrical power to the heaters, is constituted by a triac and controls energization of AC voltage by input of an instruction signal from the CPU 301 to a gate terminal. Further, also a zero-cross signal from a zero-cross signal detecting circuit is inputted to the CPU 301 (although the zero-cross signal is not shown in the block diagram), so that it is also possible to effect phase control with use of the zero-cross signal.

The temperature detection of the fixing roller 41a is carried out by converting values of the main thermistor 45 and the sub-thermistor 46 into voltage signals by the temperature detecting circuit 304 and by inputting the voltage signal to the CPU 301. The signals inputted to the CPU 301 are subjected to A/D conversion in the CPU 301, and data-converted values are checked against the temperature table of the thermistor stored in the ROM 302, so that the temperature of the fixing roller 41a is calculated.

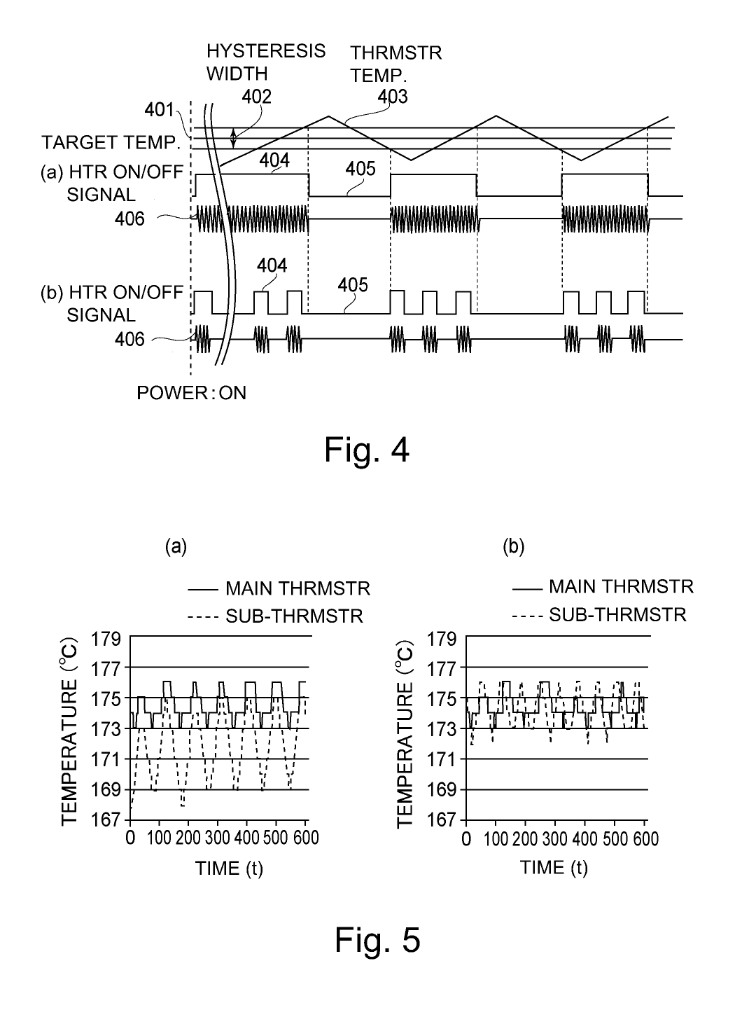

FIGS. 4(a) and 4(b) includes timing charts showing ON/OFF relationships between a temperature 403 of the thermistor and the halogen heaters. FIG. 4(a) shows turning-on control such that the respective heaters are continuously turned on until the temperature reaches a target temperature, and FIG. 4(b) shows turning-on control (time-division control in which turning-on and turning-off are repeated periodically), in the main heater 43, in which ON/OFF is repeated with a predetermined cyclic period from the turning-on of the heater until the temperature detected by the thermistor reaches the target temperature.

Conventionally, irrespective of statuses such as during stand-by (other than during a print job) and during printing (during the print job), as the thermistor used for temperature control, the main thermistor is usually used, and control of the main heater and the sub-heater is effected using the main thermistor. After a main switch is turned on, when a target temperature 401 (FIG. 4) of temperature control is set, the CPU 301 (FIG. 3) outputs a heater turning-on instruction signal 404 (FIG. 4) of each of the heaters, so that energization to the associated heater is carried out by the heater ON/OFF circuit 305 (FIG. 3) receiving the signal.

The target temperature is provided with a hysteresis width 402 (FIG. 4) of about 1° C., so that control divergence of the temperature control is prevented. When the temperature 403 of the thermistor reaches the target temperature, the CPU 301 outputs a heater turning-off instruction signal 405 of each of the heaters, so that energization to the associated heater is stopped by the heater ON/OFF circuit 305 receiving the signal. Thereafter, when the thermistor temperature decreases to the target temperature or less, the CPU 301 outputs the heater turning-on instruction signal 404 again, so that the associated heater is turned on. By repeating this sequence, the temperature control (time-division control) is carried out.

However, thermal capacity differs between the central portion and the end portion of the fixing roller 41a with respect to the longitudinal direction, and, also, wattage (normal rated power) is different between the heater 43 and the sub-heater 44. The main heater 43 always heats a region through which the sheet (as recording paper as the recording material) passes, and, therefore, the wattage thereof is about twice that of the sub-heater 44.

Therefore, when the respective heaters are continuously turned on until the temperature increases to the target temperature, as shown in FIG. 4(a), a temperature balance between the central portion and the end portion with respect to the longitudinal direction is destroyed, so that thermal uniformity of the fixing roller 41a with respect to the longitudinal direction lowers. Particularly, during non-sheet-passing other than during the print job, heat is not taken by the sheet, and, therefore, a degree of the destruction of the temperature balance between the central portion and the end portion with respect to the longitudinal direction becomes conspicuous.

For that reason, as shown in FIG. 4(b), the main heater 43 repeats ON/OFF thereof with a predetermined cyclic period from the turning-on of the heater until the temperature reaches the target thermistor temperature. As a result, slopes of temperature rise of the main thermistor 45 and the sub-thermistor 46 are controlled so as to become the same, so that not only overshooting of the temperature is suppressed, but also, a temperature difference between the central portion and the end portion with respect to the longitudinal direction is suppressed to a small level.

(Advantage and Disadvantage of Case when a Central Portion and an End Portion are Temperature-Controlled Altogether)

Here, in case when the both heaters 43 and 44 are temperature-controlled altogether by only the main thermistor 45, when the ON/OFF cyclic period of the heaters is early (short), not only overshooting of the temperature can be suppressed, but also, a temperature difference between the central portion and the end portion with respect to the longitudinal direction can be suppressed to a small level. However, an inrush of current generates every turning-on of the heater, so that a voltage fluctuation of wiring impedance frequently occurs, and, therefore, a flicker value deteriorates. Further, in a case when the both heaters 43 and 44 are temperature-controlled altogether by only the main thermistor 45, conversely, when the ON/OFF cyclic period of the heaters is slow (long), a degree of the overshooting of the temperature increases, and the temperature balance between the central portion and the end portion with respect to the longitudinal direction is destroyed.

In this embodiment, between during the print job (or during a fixing operation (during image heating)) and during a period other than during the print job (or during a period other than during the fixing operation), by switching the thermistor used for the temperature control of the respective heaters, the deterioration of the flicker value is suppressed, and, further, the thermal uniformity of the fixing roller 41a is realized. Specifically, during the print job, the temperature control is carried out for both the main heater 43 and the sub-heater 44 by the main thermistor 45. In other words, only during the print job, both the heaters 43 and 44 are subjected to the temperature control altogether by the main thermistor 45. On the other hand, during the non-sheet-passing other than during the print job, the main heater 43 is temperature-controlled by the main thermistor 45, and the sub-heater 44 is temperature-controlled by the sub-thermistor 46.

Here, “during the print job” refers to a period (time zone) that is after the main switch of the image forming apparatus is turned on and that is from feeding of the recording material, on which the toner images are formed, to the fixing nip after at least passing through the image forming portion, until the recording material has completely passed through the fixing nip. Further, the period “other than during the print job” refers to at least a portion of a period (time zone) excluding the above print job.

In this embodiment, only during the print job, by collectively subjecting both the heaters 43 and 44 to the temperature control with the use of the main thermistor, the number of times of the turning-on of the sub-heater 44 is suppressed, so that the deterioration of the flicker value can be suppressed. On the other hand, in a case when during the print job, by independently subjecting both the heaters 43 and 44 to the temperature control with the use of the corresponding thermistors, respectively, that is, in a case when the temperature control of the sub-heater 44 is carried out using the sub-thermistor 46, ON/OFF of the sub-thermistor 46 frequently occurs, so that the flicker value deteriorates.

This results from a phenomenon such that during the print job, heat of the fixing roller at the portion (temperature-) detected by the sub-thermistor is taken or is not taken by the sheet. In this embodiment, a center of the fixing roller with respect to the longitudinal direction is a basis of feeding of the recording material (sheet). For that reason, at the longitudinal central portion of the fixing roller, even when the recording material having any width size is introduced into the fixing nip, the heat is taken. For that reason, the temperature detected by the main thermistor provided at the longitudinal central portion of the fixing roller is stabilized irrespective of the width size of the sheet passing through the fixing nip.

On the other hand, at the both end portions of the fixing roller with respect to the longitudinal direction, the heat is taken when a large-sized (for example, A3-sized) sheet is introduced, but is not taken when a small-sized (for example, postcard-sized) sheet is introduced in to the fixing nip. For that reason, the temperature detected by the sub-thermistor provided at the longitudinal one end portion of the fixing roller is influenced by the width size of the sheet introduced into the fixing nip. Particularly, the fixing roller in this embodiment is small in thermal capacity at the longitudinal end portion, and, therefore, the temperature is liable to change. That is, in a case when a plurality of sheets (papers, recording materials) different in size is used in a mixture, ON/OFF of the sub-thermistor 46 frequently occurs.

Incidentally, a cause of frequent occurrence of the ON/OFF of the sub-thermistor 46 is not only the use of the sheets in mixture. When a feeding position of the sheet changes, a temperature at a position, of the fixing roller, where the sub-thermistor detects the temperature is taken or is not taken by the sheet. For example, in a case when a reciprocating mechanism for reciprocating the sheet feeding position is provided, a sheet passing position changes during the print job. Further, when at least one of the fixing roller and the pressing roller is replaced with a belt unit, and belt shift control of the belt unit control is carried out, the sheet feeding position changes during the print job.

For that reason, it is desirable that the main thermistor and the sub-thermistor are collectively controlled by the main thermistor during the job.

On the other hand, in this embodiment, during the period other than the print job, both heaters 43 and 44 are independently controlled. In order to suppress the deterioration of flicker, even when the turning-on period of the heater is made slow, the temperature uniformity of the fixing roller 41a with respect to the longitudinal direction is maintained. By this, compared with a case when both heaters 43 and 44 are collectively controlled by the main thermistor, the lowering in temperature at both end portions of the fixing roller with respect to the longitudinal direction can be suppressed.

Incidentally, as regards the temperature control in this embodiment, the temperature during the print job is higher by several ° C. than the temperature during the period other than during the print job, but is not a level such that the temperature uniformity is destroyed and a fixing property lowers, and an image non-uniformity, or the like, is generated. That is, this increase in temperature is not nearly a disadvantage, but rather, an advantage, such that unnecessary turning-on of the sub-heater 44 is suppressed, and the deterioration of the flicker value can be suppressed is large.

FIGS. 5(a) and 5(b) includes data of comparison of temperatures of the main thermistor 45 and the sub-thermistor 46 when ON/OFF of the heaters is carried out with a long cyclic period as to the temperature control during stand-by (during the period other than during the print job).

FIG. 5(a) includes data in a case when both the main heater 43 and the sub-heater 44 are subjected to the temperature control with the main thermistor 45, and a temperature change of the main thermistor 45 is 3° C. and a temperature change of the sub-thermistor 46 is 8° C. Also, a temperature difference between the main thermistor 45 and the sub-thermistor 46 increases.

On the other hand, FIG. 5(b) includes data in a case when the main heater 43 is subjected to the temperature control with the main thermistor 45 and the sub-heater 44 is subjected to the temperature control with the sub-thermistor 46. A temperature change of the main thermistor 45 is 3° C. and a temperature change of the sub-thermistor 46 is 4° C. Also, a temperature difference between the main thermistor 45 and the sub-thermistor 46 is less than that in the case of FIG. 5(a), so that it is understood that the temperature uniformity is maintained.

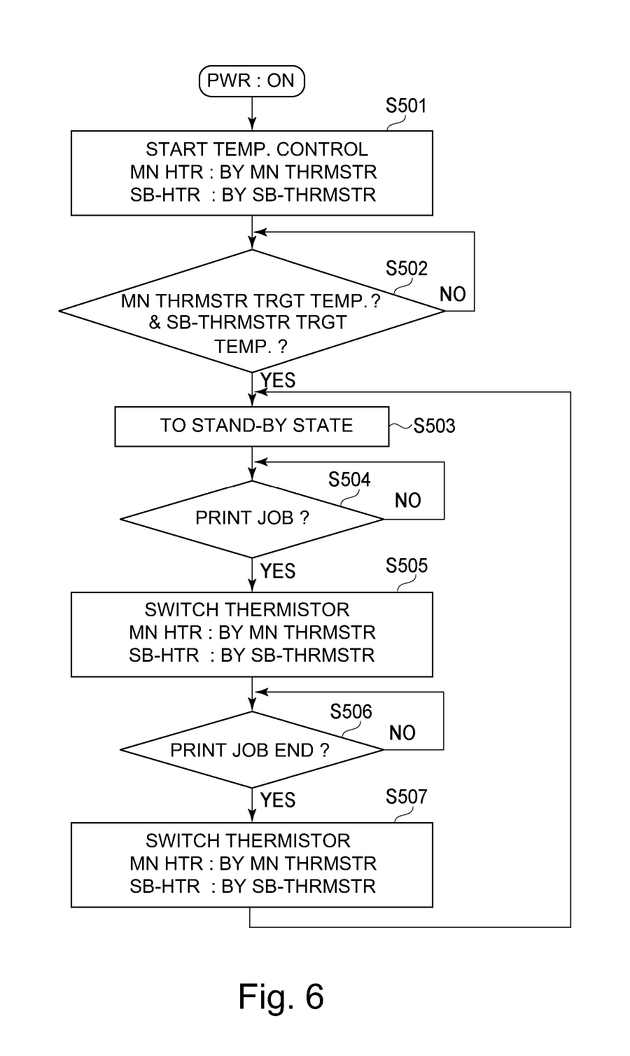

FIG. 6 is a flowchart of heater control carried out by the CPU 301 in this embodiment. When the main switch (power source) is turned on, the CPU 301 sets target temperatures and starts temperature control in such a manner that the main thermistor 45 is used for the main heater 43 and the sub-thermistor 46 is used for the sub-heater 44 (S601). Then, the CPU 301 discriminates whether or not the temperature of the main thermistor 45 and the temperature of the sub-thermistor 46 reach the target temperatures (S502), when both the temperatures of the main thermistor 45 and the sub-thermistor 46 reach the target temperatures, the printer moves to a stand-by state (S503).

After transition to the stand-by state, the CPU 301 discriminates whether or not a print job requirement exists (S504). In a case when the print job does not exist, the CPU 301 waits for the print job requirement. When the CPU 301 receives the print job requirement, the CPU 301 switches the control so that the temperature control of the main heater 43 is carried out by the main thermistor 45 and that, also, the temperature control of the sub-heater 44 is carried out by the main thermistor 45 (S505).

Thereafter, the CPU 301 discriminates whether or not the print job ends, and in a case when the print job does not end, the temperature control is continued as it is. In a case when the print job ends, the CPU 301 switches the control so that the temperature control of the main heater 43 is carried out by the main thermistor 45 and that the temperature control of the sub-heater 44 is carried out by the sub-thermistor 46 (S507), and the printer moves to the stand-by state of S503.

As described above, in this embodiment, the thermistor used in the temperature control of each of the heaters is switched between during the print job and during the period other than during the print job. By this, an end portion temperature change of the fixing roller can be suppressed to a minimum (the temperature during the print job is higher by several ° C. than the temperature during the period other than during the print job, but is not a level such that the temperature uniformity is destroyed and a fixing property lowers, and an image non-uniformity, or the like, is generated).

Further, in this embodiment, the turning-on period of the heater can be made slow, with the result that the deterioration of the flicker value is suppressed and, thus, the temperature uniformity of the fixing roller can be maintained and a stable fixing property can be ensured. That is, during the period other than during the print job, even when both heaters 43 and 44 are independently controlled and the turning-on period of the heaters is made slow for suppressing the deterioration of the flicker value, the temperature uniformity of the fixing roller 41a with respect to the longitudinal direction is maintained.

In the description above, preferred embodiments of the present invention were described, but the present invention is not limited to these embodiments, and can be variously modified and changed within a range of the substance thereof.

### Modified Embodiment 1

In the above-described embodiment, as the period other than during the print job, the stand-by period (during the stand-by state) was described, but may also be a warming-up period (during warming-up).

### Modified Embodiment 2

In the above-described embodiment, the members for forming the nip were the heat roller 41a and the pressing roller 41b, but the present invention is not limited thereto. For example, one of the members may also be a rotatable endless belt. Further, the other member may also be a rotatable endless belt.

### Modified Embodiment 3

In the above-described embodiment, the pressing roller 41b presses the heat roller 41a, but the present invention is not limited thereto, and a constitution in which the heat roller 41a presses the pressing roller 41b may also be employed.

### Modified Embodiment 4

In the above-described embodiment, as the recording material (sheet), the recording paper was described as an example, but another form (material) may also be used when the toner image can be formed on another form. For example, an envelope, a postcard, a seal, a resin sheet, and an overhead projector (OHP) sheet, may also be used.

### Modified Embodiment 6

In the above-described embodiment, as the image heating apparatus, the fixing device for fixing the unfixed toner image on the sheet was described as an example, but the present invention is not limited thereto, and in order to improve glossiness of the image, the present invention is also similarly applicable to a device (apparatus) for heating and pressing the toner image temporarily fixed on the sheet.

### INDUSTRIAL APPLICABILITY

According to the present invention, an image heating apparatus capable of suppressing flicker while satisfactorily performing image heating is provided.

1. An image heating apparatus comprising:
a first rotatable member and a second rotatable member for constituting a nip for heating a toner image on a sheet;
a first heater for heating said first rotatable member, said first heater having a heat generation power that is higher in a central portion than in opposite end portions with respect to a longitudinal direction of said first rotatable member;
a second heater for heating said first rotatable member, said second heater having a heat generation power that is higher in opposite end portions than in a central portion with respect to the longitudinal direction of said first rotatable member;
a first sensor for detecting a temperature of a central portion of said first rotatable member with respect to the longitudinal direction;
a second sensor for detecting a temperature of an end portion of said first rotatable member with respect to the longitudinal direction; and
a controller for controlling electrical power supply to said first heater and said second heater,
wherein, in an image heating process operation, said controller controls the electrical power supply to said first heater and said second heater in response to an output of said first sensor, and wherein, in a stand-by state, said controller controls the electrical power supply to said first heater in response to the output of said first sensor and controls the electrical power supply to said second heater in response to an output of said second sensor.

2. An apparatus according to claim 1, wherein in a warming-up period, said controller control the electrical power supply to said first heater in response to an output of said first sensor and controls the electrical power supply to said second heater in response to an output of said second sensor.

3. An apparatus according to claim 1, wherein said first heater and said second heater include halogen heaters.

4. An image heating apparatus comprising:
a first rotatable member and a second rotatable member for constituting a nip for heating a toner image on a sheet;
a first heater for heating said first rotatable member, said first heater having a heat generation power that is higher in a central portion than in opposite end portions with respect to a longitudinal direction of said first rotatable member;
a second heater for heating said first rotatable member, said second heater having a heat generation power that is higher in opposite end portions than in a central portion with respect to the longitudinal direction of said first rotatable member;
a first sensor for detecting a temperature of a central portion of said first rotatable member with respect to the longitudinal direction;
a second sensor for detecting a temperature of an end portion of said first rotatable member with respect to the longitudinal direction; and
a controller for controlling electrical power supply to said first heater and said second heater,
wherein, in an image heating process operation, said controller controls the electrical power supply to said first heater and said second heater in response to an output of said first sensor, and
wherein, in a warming-up period, said controller control the electrical power supply to said first heater in response to an output of said first sensor and controls the electrical power supply to said second heater in response to an output of said second sensor.

5. An apparatus according to claim 4, wherein said first heater and said second heater include halogen heaters.
